(19) United States
(12) Patent Application Publication
(10) Pub. No.: US 2011/0166248 A1
(43) Pub. Date: Jul. 7, 2011

(54) COPOLYMER FOR ENHANCING THE wETTABILITY OF SILICONE HYDROGEL, SILICONE HYDROGEL COMPOSITION COMPRISING THE SAME AND OCULAR ARTICLE MADE THEREFROM

(75) Inventors: Yu-Fang HSU, Taipei (TW); Ching-Ping HUANG, Taipei (TW); Chia-Chang LIU, Taipei (TW)

(73) Assignee: FAR EASTERN NEW CENTURY CORPORATION

(21) Appl. No.: 12/981,642

(22) Filed: Dec. 30, 2010

(30) Foreign Application Priority Data
Dec. 31, 2009 (TW) 098146455

(51) Int. Cl. C08L 83/07; C08F 130/08; C08F 4/04; C08F 4/34; C08F 26/10

(52) U.S. Cl. 523/107; 526/279; 526/219.6; 526/232; 526/227; 526/230.5; 526/264; 526/260; 524/535; 524/533; 524/530

(57) ABSTRACT

The present invention provides a reactive hydrophilic copolymer consisting essentially of units formed by ethylenically unsaturated hydrophilic monomers and units of formula (I) or (II) formed by ethylenically unsaturated monomers having alkoxy silane functional groups in a random order:

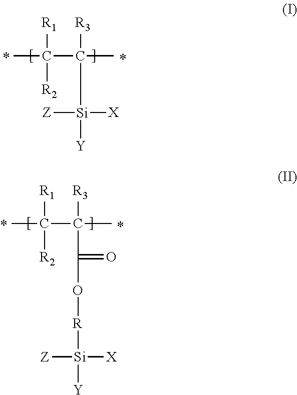

wherein the copolymer has a molecular weight of at least 50,000, and wherein R₁, R₂ and R₃ can be the same or different and are independently selected from H or C₁₋₃ alkyl; R is C₁₋₃ alkyl; X, Y and Z can be the same or different and are independently selected from R′ or OR′, provided that at least one of X, Y and Z is OR′; R′ is H or C₁₋₃ alkyl; and the equivalent ratio of the units formed by ethylenically unsaturated hydrophilic monomers to the units of formula (I) or (II) is within the range of 5/1 to 200/1. The present invention also provides silicone hydrogel compositions comprising the reactive hydrophilic copolymer of the present invention and ocular articles made therefrom.

### BACKGROUND OF THE INVENTION

1. Field of the Invention

The present invention relates to a reactive hydrophilic copolymer, which is added to a silicone hydrogel formulation for forming an ocular article to improve the wettability of the material surface. The present invention also relates to a modified ocular article made therefrom, and in particular, contact lenses or intraocular lens (IOL).

2. Description of the Prior Art

Contact lenses have a history of nearly one hundred years, and are considered one of the important applications of biomedical materials. With the advances in technology, the material thereof is also developing towards high oxygen permeability and high comfort. In the 1950s, Czech scientists made hydrogel from poly(hydroxyethyl methacrylate (HEMA) and invented soft contact lenses.

Generally, the necessary properties of contact lenses are safety, good light transmittance and high oxygen permeability; improving the oxygen permeability rate of lenses is especially an important direction for development. The conventional method for improving the oxygen permeability rate of HEMA hydrogel material is to reduce the thickness of the lenses, but this is always accompanied by the disadvantageous loss of mechanical properties of the lenses. In the past two decades, a silicone material has been added to the lenses to enable oxygen molecule to permeate the lenses and reach the cornea by means of the high oxygen permeability of the silicon material, so not only the oxygen permeability rate but also the comfort when wearing the contact lenses is improved. Presently, the most common silicon material is silicone (or polysiloxane). However, the silicone material has poor wettability and is not hydrophilic, so different methods have been developed subsequently to improve the wettability of silicone molecule.

Generally, the methods for improving the wettability of silicone hydrogel can be substantially divided into two types.

(1) Hydrophilic post-processing treatment of molded lenses: For example, plasma processing of silicone hydrogel lens surface is disclosed in U.S. Pat. No. 4,214,014, and in U.S. Pat. No. 6,099,852, a silane coupling agent is coated onto the surface of the molded silicone hydrogel lenses, and then the lenses are immersed in a hydrophilic material, so that the hydrophilic material is grafted onto the lenses surface through chemical bonding, to improve the wettability of the lens surface. Although this post-processing method can improve the wettability, it is not frequently used in practice due to the complexity, poor efficiency, and thus increased fabrication cost of the process.

(2) Adding a hydrophilic molecule to the silicone hydrogel formulation: This method can improve the wettability of the lens surface without influencing the original process, and thus has become the mainstream method for improving the wettability of contact lenses.

At the early stage, the method of adding a hydrophilic molecule is mainly to introduce a reactive hydrophilic molecule capable of being directly co-polymerized with the main formulation ingredients into the main ingredients of a silicone hydrogel, so as to directly achieve the wetting effect during the fabrication of lenses. For example, U.S. Pat. Nos. 5,219,965, 5,364,918, and 5,525,691 disclose introducing ethylenically reactive functional groups into the structure of a hydrophilic molecule, which can be chemically bonded with the materials having vinyl group in the silicone hydrogel formulation, so that the hydrophilic segment is grafted into the whole silicone hydrogel formulation through covalent bond; the hydrophilic material used is mainly poly-N-vinylpyrrolidone (PVP) having a molecular weight of 500-10,000. However, due to insufficient length of the hydrophilic segment, the effect on improving the wettability of the lens surface generated is limited.

U.S. Pat. No. 6,367,929 discloses that the wettability of the lenses is significantly improved by directly adding a hydrophilic polymer (e.g., PVP) having no reactivity but high molecular weight (at least above 50 kDa) to the silicone hydrogel formulation. However, as the whole molecular chain of the molecule is hydrophilic and there is no segment compatible with the silicon material, uneven transmittance may occur in the formed lenses due to insufficient compatibility. Therefore, U.S. Pat. No. 7,052,131, derived from the foregoing patent, discloses that when high molecular weigh PVP is used, an additional compatibilizing agent is introduced so that, by action of the compatibilizing agent, the PVP can be compatible with the silicone hydrogel. However, the addition of the compatibilizing agent not only increases the complexity of the formulation but also makes it necessary to consider the molecular properties of the original formulation during the design and selection of the compatibilizing agent.

On the other hand, U.S. Pat. Nos. 7,468,397 and 7,528,208 disclose that a hydrophilic silicone-containing prepolymer is used as the main ingredient for fabricating the contact lenses, the molecule of which is a random copolymer prepared by a long-chain siloxane and a hydrophilic quaternary amine salt and has ethylenically reactive functional groups on the end, so the molecules can be polymerized with each other to form lenses, resulting in improved compatibility; besides, the oxygen permeability and structural strength of the lenses are provided by the siloxane segment, and the wettability is provided by the hydrophilic quaternary amine salt segment. Therefore, with this molecular design, not only can the molecule be directly used to fabricate lenses, but also both wettability and compatibility can be improved. However, because the molecular structure of the prepolymer has to be specially designed, the prepolymer is only useful in certain silicone hydrogel systems, and thus the method is complex and limited in use and has poor efficiency.

In view of the above, the industry still needs a technical solution which can improve the wettability of the silicone hydrogel material surface without compromising compatibility, practical convenience or oxygen permeability rate. As a result of extensive research, the inventors of the present invention have developed a novel polymer wetting agent by adding a molecule to the silicone hydrogel formulation, which molecule contains both a hydrophilic segment and a segment containing alkoxy silane reactive functional groups and is thus able to solve the above problems effectively.

### SUMMARY OF THE INVENTION

Accordingly, the present invention is directed to a reactive hydrophilic copolymer consisting essentially of units formed by ethylenically unsaturated hydrophilic monomers and units of formula (I) or (II) formed by ethylenically unsaturated monomers having alkoxy silane functional groups in a random order:

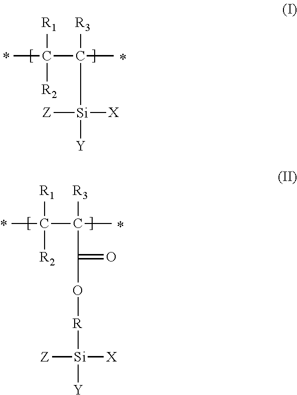

in which the copolymer has a molecular weight of at least 50,000, and R₁, R₂ and R₃ can be the same or different and are independently selected from H or C₁₋₃ alkyl; R is C₁₋₃ alkyl; X, Y and Z can be the same or different and are independently selected from R′ or OR′, provided that at least one of X, Y and Z is OR′; R′ is H or C₁₋₃ alkyl; and the equivalent ratio of the units formed by ethylenically unsaturated hydrophilic monomers to the units of formula (I) or (II) is within the range of 5/1 to 200/1.

The present invention is further directed to a silicone hydrogel composition, which contains:

(a) a monomer mixture for forming a silicone hydrogel, in which the mixture contains at least a silicone monomer having alkoxy silane functional groups; and

(b) the reactive hydrophilic copolymer of the present invention.

The present invention is still further directed to an ocular article made from the silicone hydrogel composition of the present invention.

### BRIEF DESCRIPTION OF THE DRAWING

FIG. 1 is an NMR spectrum showing the chemical bonding test results of the reactive hydrophilic copolymer of the present invention.

### DETAILED DESCRIPTION OF THE INVENTION

In prior art, in order to improve the wettability of the silicone hydrogel surface significantly, addition of a high molecular weight hydrophilic compound is required. However, in order to avoid the influence on the optical properties of lenses due to incompatibility between the hydrophilic compound and the silicone hydrogel, an additional compatibilizing agent is generally required.

Compared with prior art, the present invention promotes both surface wettability and compatibility by providing a reactive hydrophilic copolymer containing a hydrophilic segment and a segment containing alkoxy silane reactive functional groups. Particularly, when the reactive hydrophilic copolymer of the present invention is added to the silicone hydrogel formulation, the hydrophilic segment in the copolymer can improve the surface wettability of the silicone hydrogel material. Meanwhile, as the segment containing alkoxyl silane reactive functional groups in the copolymer has high affinity to the silicone molecule in the formulation, and can be chemically bonded to the silicone molecule in the formulation through the alkoxy silane functional groups, the hydrophilic segment in the copolymer is connected to the silicone hydrogel main body, thereby improving the compatibility of the whole formulation. Therefore, the silicone hydrogel formulation with the reactive hydrophilic copolymer of the present invention added can be directly solidified without the need for an additional compatibilizing agent or complex surface processing steps to fabricate an ocular article (e.g., contact lenses) having good optical properties and surface wettability. Further, as there is a covalent bond between the reactive hydrophilic copolymer of the present invention and the silicone hydrogel main body, it does not need to worry about the problem associated with the release of material and thus the safety of the wearer is improved.

The reactive hydrophilic copolymer of the present invention is consisting essentially of units formed by ethylenically unsaturated hydrophilic monomers and units of formula (I) or (II) formed by ethylenically unsaturated monomers having alkoxy silane functional groups in a random order:

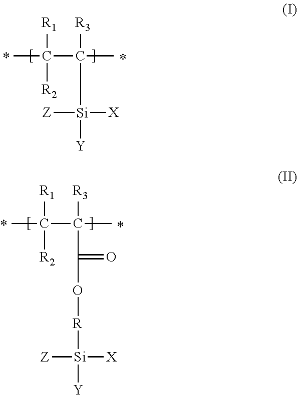

in which R₁, R₂ and R₃ can be the same or different and are independently selected from H or C₁₋₃ alkyl; R is C₁₋₃ alkyl; X, Y and Z can be the same or different and are independently selected from R′ or OR′, provided that at least one of X, Y and Z is OR′; R′ is H or C₁₋₃ alkyl.

The reactive hydrophilic copolymer of the present invention is obtained by copolymerizing one or more hydrophilic monomers having ethylenically unsaturated functional groups and one or more ethylenically unsaturated monomers having alkoxy silane functional groups. The copolymerization is preferably performed in the presence of an initiator. The initiator suitable for the preparation of the reactive hydrophilic copolymer of the present invention includes, but is not limited to, azo compounds, for example, but not limited to, 2,2′-azobis(isobutyronitrile) (AIBN), 2,2′-azobis(2,4-dimethylpentanenitrile), 2,2′-azobis(2-methylpropanenitrile), 2,2′-azobis(2-methylbutanenitrile); peroxides, for example, but not limited to, benzyl peroxide, acetyl peroxide, lauroyl peroxide, decanoyl peroxide, stearoyl peroxide, benzoyl peroxide, tert-butyl peroxypivalate, peroxydicarbonate, and the like, and mixtures thereof. Preferably, an azo compound (e.g. AIBN) is used as initiator.

The units of hydrophilic monomers in the reactive hydrophilic copolymer of the present invention are derived from one or more hydrophilic monomers having ethylenically unsaturated functional groups. Any one of the known hydrophilic monomers for fabricating the silicone hydrogel material disclosed in prior art can be used as the hydrophilic monomer material, for example, those disclosed in U.S. Pat. Nos. 5,219,965, 5,364,918, 5,525,691, 6,367,929, and 7,052,131, which are incorporated hereinto by reference in their entirety.

According to an embodiment of the present invention, the hydrophilic monomers having ethylenically unsaturated functional groups useful in the present invention include, but are not limited to, ethylenically unsaturated carboxylic acid, for example, methacrylic acid (MA) and acrylic acid; hydrophilic vinyl carbonate, for example, vinyl acetate; acrylate, for example, ethylene glycol dimethacrylate (EGDMA), 2-hydroxyethyl methacrylate (HEMA), 2-hydroxyethyl acrylate, glycerol methacrylate, and 2-dimethylaminoethyl acrylate; vinyl amide, for example, N-vinyl-N-methyl acetamide, N-vinyl-formamide; vinyl lactam, for example, N-vinyl pyrrolidone (NVP) and acryloylmorpholine; acrylamide, for example, methacrylamide, N,N-dimethylacrylamide (DMA), N,N-diethylacrylamide, 2-hydroxyethyl methacrylamide, N-isopropylacrylamide; and mixtures thereof.

According to an embodiment of the present invention, the ethylenically unsaturated monomers having alkoxy silane functional groups useful in preparation of the reactive hydrophilic copolymer of the present invention include, but are not limited to, vinyltrimethoxysilane, vinyltriethoxysilane, diethoxy(methyl)vinylsilane, 3-methacryloxypropyl-methyldimethoxysilane, 3-methacryloxypropyl-methyldiethoxysilane, 3-methacryloxypropyl-trimethoxysilane, 3-methacryloxypropyl-triethoxysilane, vinyltri(isopropoxy)silane, vinyltripropoxysilane, and mixtures thereof.

The equivalent ratio of the units formed by ethylenically unsaturated hydrophilic monomers to the units of formula (I) or (II) in the reactive hydrophilic copolymer of the present invention reflects the ratio of the hydrophilic and hydrophobic segments in the entire reactive hydrophilic copolymer; especially when the molecular weight is high, the ratio has a great influence on the properties of the lens. If the ratio is too high (where there are too few units of formula (I) or (II)), incompatibility may occur. On the other hand, if the ratio is too low (where there are too few units formed by ethylenically unsaturated hydrophilic monomers), wettability cannot be achieved. Therefore, in synthesizing the reactive hydrophilic copolymer of the present invention, the equivalent ratio of the units formed by ethylenically unsaturated hydrophilic monomers to the units of formula (I) or (II) in the obtained copolymer is preferably in the range of 5/1 to 200/1, more preferably in the range of 10/1 to 150/1, and most preferably in the range of 20/1 to 100/1. The reactive hydrophilic copolymer obtained preferably has a molecular weight of at least 50,000, and more preferably 80,000 to 1,300,000.

As described above, the reactive hydrophilic copolymer of the present invention contains both hydrophilic segment and segment containing alkoxyl silane reactive functional groups. When the copolymer is added to the monomer mixture for forming the silicone hydrogel, its hydrophilic segment improves the surface wettability of the silicone hydrogel material, and the compatibility is improved by reaction and bonding between the segment containing alkoxyl silane reactive functional groups of the copolymer and the monomers of the silicone hydrogel, in the presence of an initiator. Therefore, by adding the reactive hydrophilic copolymer of the present invention to the monomer mixture of the silicone hydrogel, a silicone hydrogel material having good light transmittance, oxygen permeability and wettability can be fabricated without the need for an additional compatibilizing agent.

Accordingly, the present invention also provides a silicone hydrogel composition, which includes:

(a) a monomer mixture for forming a silicone hydrogel, in which the mixture contains at least a silicone monomer having alkoxy silane functional groups; and

(b) the reactive hydrophilic copolymer of the present invention;

wherein the amount of the reactive hydrophilic copolymer used is preferably 1 to 20 parts by weight, and more preferably 3 to 15 parts by weight, based on 100 parts by weight of the total weight of the monomer mixture for forming the silicone hydrogel.

Herein, the term “monomer” includes polymerizable low-molecular weight compounds (i.e., generally having a number average molecular weight of below 700), and polymerizable medium- and high-molecular weight compounds or polymers, and sometimes is also called macromonomer (i.e., generally having a number average molecular weight of above 700). Therefore, it should be understood that, herein, the terms “silicone monomer” and “hydrophilic monomer” include monomers, macromonomers, and prepolymers. Prepolymers refer to partially polymerized monomers or monomers that can be further polymerized.

Herein, the term “silicone (or polysiloxane)” refers to organic polymer materials containing at least 5 wt % silicone (—OSi— bond), preferably 10 to 100 wt % silicone, and more preferably 30 to 90 wt % silicone. The hydration and cross-linking polymerization system of hydrogel contains water in equilibrium state. Generally, the water content of hydrogel is higher than 5 wt %, and more commonly in the range of 10 to 80 wt %. The silicone hydrogel (i.e., silicone-containing hydrogel) is generally prepared by polymerizing a monomer mixture containing at least one silicone-containing monomer and at least one hydrophilic monomer.

Suitable silicon-containing monomers useful for forming a silicone hydrogel are well known in the art, and include, but are not limited to, those disclosed in U.S. Pat. Nos. 4,136,250, 4,153,641, 4,740,533, 4,954,587, 5,010,141, 5,034,461, 5,070,215, 5,079,319, 5,115,056, 5,260,000, 5,310,779, 5,336,797, 5,358,995, 5,387,632, 5,451,617, 5,486,579, and WO 96/31792, which are incorporated hereinto by reference in their entirety.

According to an embodiment of the present invention, suitable silicone monomers useful in the silicone hydrogel composition of the present invention include, but are not limited to, tris(trimethylsiloxy)silylpropyl methacrylate, bis(trimethylsiloxy)methylsilylpropyl methacrylate, pentamethyldisiloxanepropyl methacrylate, tris(trimethylsiloxy)silyl propyloxyethyl methacrylate, tris(polydimethylsiloxy)silylpropyl methacrylate, (trimethylsiloxy)-3-methacryloxypropylsilane (TRIS), ethylenically unsaturated organic siloxane prepolymers, for example, oligomers of acrylated siloxane polyalkyleneoxide copolymer-type (for example, but not limited to, CoatOsil 3509), and mixtures thereof.

In order to make the reactive hydrophilic copolymer of the present invention take part in the polymerization with the silicone hydrogel to improve the compatibility, at least one silicone monomer having alkoxy silane functional groups must be comprised in the monomer mixture for forming the silicone hydrogel. Suitable silicone monomers having alkoxy silane functional groups include, but are not limited to, 3-(trimethoxysilyl)propyl methacrylate (TPM), 3-(triethoxysilyl)propyl methacrylate, 3-(diethoxymethylsilyl)-propyl methacrylate, vinyltrimethoxysilane, vinyltriethoxysilane, diethoxy(methyl)vinylsilane, 3-methacryloxypropyl-methyldimethoxysilane, 3-methacryloxypropyl-methyldiethoxysilane, 3-methacryloxypropyl-trimethoxysilane, 3-methacryloxypropyl-triethoxysilane, vinyltri(isopropoxy)silane, vinyltripropoxysilane, and mixtures thereof.

According to the present invention, the amount of the silicone monomers used is preferably 10 to 70 parts by weight, and more preferably 20 to 60 parts by weight, based on 100 parts by weight of the total weight of the monomer mixture for forming the silicone hydrogel. Further, based on 100 parts by weight of the total weight of the silicone monomers contained in the monomer mixture, the amount of the silicone monomers having alkoxy silane functional groups used is preferably at least above 5 parts by weight, and more preferably above 10 parts by weight. According to an embodiment of the present invention, the silicone monomers in the monomer mixture can all be silicone monomers having alkoxy silane functional groups.

Suitable hydrophilic monomers useful in the silicone hydrogel composition of the present invention include any known hydrophilic monomers for fabricating a silicone hydrogel material disclosed in the prior art, for example, those disclosed in U.S. Pat. Nos. 5,219,965, 5,364,918, 5,525,691, 6,367,929, and 7,052,131, which are incorporated hereinto by reference in their entirety. Suitable hydrophilic monomers include, but are not limited to, ethylenically unsaturated carboxylic acid, for example, methacrylic acid (MA) and acrylic acid; hydrophilic vinyl carbonate, for example, vinyl acetate; acrylate, for example, ethylene glycol dimethacrylate (EGDMA), 2-hydroxyethyl methacrylate (HEMA), 2-hydroxyethyl acrylate, glycerol methacrylate, and 2-dimethylaminoethyl acrylate; vinyl amide, for example, N-vinyl-N-methyl acetamide, N-vinyl-formamide; vinyl lactam, for example, N-vinyl pyrrolidone (NVP) and acryloylmorpholine; acrylamide, for example, methacrylamide, N,N-dimethylacrylamide (DMA), N,N-diethylacrylamide, 2-hydroxyethyl methacrylamide, N-isopropylacrylamide; and mixtures thereof. The amount of the hydrophilic monomers used is preferably 30 to 90 parts by weight, and more preferably 40 to 80 parts by weight, based on 100 parts by weight of the total weight of the monomer mixture for forming the silicone hydrogel.

In co-polymerization, the silicone hydrogel composition of the present invention can be cast molded through hardening by UV polymerization, using free radical thermal initiators and heat or combinations thereof. Representative free radical thermal polymerization initiators are organic peroxides, for example, acetyl peroxide, lauroyl peroxide, decanoyl peroxide, stearoyl peroxide, benzoyl peroxide, tert-butyl peroxypivalate, peroxydicarbonate, and commercially available thermal initiators, such as LUPERSOL® 256,225 (Atofina Chemical, Philadelphia, Pa.) and the like. The initiators are used in a concentration of about 0.01 to 2 wt % of the total weight of the monomer mixture. Representative UV initiators are known in the art, such as, but not limited to, benzoin methyl ether, benzoin ethyl ether, DAROCUR® 1173, 1164, 2273, 1116, 2959, 3331, IGRACURE® 651 and 184 (Ciba Specialty Chemicals, Ardsley, N.Y.).

As known by those of ordinary skill in the art, besides the polymerization initiators above, the silicone hydrogel composition of the present invention can optionally contain other components, for example, additional colorants, UV absorbents, and additional processing aids, for example, those known in the art of contact lenses.

The silicone hydrogel generated by adding the reactive hydrophilic copolymer of the present invention has high oxygen permeability, low lipid adhesion, excellent surface wettability, and high light transmittance, and is thus very suitable for use as an ocular article, especially contact lenses or intraocular lens (IOL).

The copolymer obtained from the silicone hydrogel composition of the present invention can be formed into contact lenses through other conventional methods, for example, the spin casting process disclosed in U.S. Pat. Nos. 3,408,429 and 3,496,254, the cast molding process disclosed in U.S. Pat. No. 5,271,875, and the compression molding process disclosed in U.S. Pat. Nos. 4,084,459 and 4,197,266. The polymerization of the monomer mixture can be performed in a spinning die or a fixed die corresponding to the shape of the desired contact lenses. If necessary, the thus obtained contact lenses can be further subjected to mechanical finishing. The polymerization can also be performed in a suitable die or container to get a button-shaped, plate-shaped, or rod-shaped contact lens material, which can then be processed (for example, cutting or polishing with a lathe or laser) to get the contact lenses with the desired shape.

The following examples are used to further explain the present invention, but not to limit the scope of the present invention. The modifications and variations easily made by those of ordinary skill in the art are within the scope of the disclosure of the specification and the appended claims of the present invention.

### EXAMPLES

### Sources of Chemicals

1. Vinyl trimethoxysilane (VTMOS): available from TOPCO Technologies Corp.; product No. KBM1003.

2. N-vinyl pyrrolidone (NVP): available from ALDRICH; product No. CAS:88-12-0.

3. Acrylated siloxane polyalkyleneoxide copolymer: available from GE silicones; product name: CoatOsil®3509.

4. (trimethylsiloxy)-3-methacryloxypropylsilane (TRIS): available from Gelest; product No. CAS:17096-07-0.

5. 2-hydroxyethyl methacrylate (HEMA): available from ACROS; product No. CAS:868-77-9.

6. 3-(trimethoxysilyl)propyl methacrylate (TPM): available from ALDRICH; product No. CAS:2530-85-0.

7. 2,2′-azobis-isobutyronitrile (AIBN)): available from Showa Chemical Corp.; product No. CAS:78-67-1.

8. Methacrylic acid (MA)): available from Double Bond Chemical Ind. Co., Ltd.; product No. 79-41-4.

9. DAROCUR 1173 (2-hydroxy-2-methyl-1-phenyl-1-propanone): available from Ciba Specialty Chemicals; product No. CAS:7473-98-5.

10. Ethylene glycol dimethacrylate (EGDMA): available from Alfa Aesar; product No. CAS:97-90-5.

### Preparation of Reactive Hydrophilic Copolymer

### Example 1

30 g NVP were taken and placed in a reaction bottle, and 0.4 g vinyltrimethoxysilane (VTMOS) and 50 mL methanol were added. The temperature was controlled at 60° C., and the reaction was refluxed under nitrogen gas for 1 hr. Next, the temperature was raised to 90° C., 30 mg AIBN was added, the reaction was refluxed for 2 hr, and then the temperature was returned to room temperature to terminate the reaction. 100 mL methanol were added for dilution, and the resulting solution was placed in a vacuum oven at 60° C. to remove the solvent, giving a transparent product. The product was cooled and solidified with liquid nitrogen, and ground with a grinder, to get a transparent powder-like reactive hydrophilic copolymer, the average molecular weight of which was measured to be 83422 g/mol with gel permeation chromatography.

### Example 2

The feed ratio and reaction conditions were the same as those in Example 1, except that the amount of AIBN was changed to 10 mg and the refluxing time was increased to 4.5 hr. A transparent powder-like reactive hydrophilic copolymer was obtained, the average molecular weight of which was measured to be 249063 g/mol with gel permeation chromatography.

### Example 3

The feed ratio and reaction conditions were the same as those in Example 1, except that the amount of AIBN was changed to 5 mg and the refluxing time was increased to 15 hr. A transparent powder-like reactive hydrophilic copolymer was obtained, the average molecular weight of which was measured to be 499557 g/mol with gel permeation chromatography.

### Example 4

The feed ratio and reaction conditions were the same as those in Example 1, except that the amount of AIBN was changed to 2 mg and the refluxing time was increased to 24 hr. A transparent powder-like reactive hydrophilic copolymer was obtained, the average molecular weight of which was measured to be 1244112 g/mol with gel permeation chromatography.

### Example 5

The feed ratio and reaction conditions were the same as those in Example 1, except that the amount of VTMOS was changed to 4 g. A transparent powder-like reactive hydrophilic copolymer was obtained, the average molecular weight of which was measured to be 93356 g/mol with gel permeation chromatography.

### Example 6

The feed ratio and reaction conditions were the same as those in Example 1, except that the amount of VTMOS was changed to 2 g. A transparent powder-like reactive hydrophilic copolymer was obtained, the average molecular weight of which was measured to be 87802 g/mol with gel permeation chromatography.

### Preparation of Silicone Hydrogel Material

### Example 7

A silicone hydrogel composition was formulated by mixing the following monomers: TPM, TRIS, CoatOsil, NVP, HEMA and MA, with the weight ratios thereof being 7.3/32.83/14.62/31.66/12.25/1.34, respectively, and 30 wt % isopropanol was added as dispersant on the basis of the total weight of the monomers. After being mixed uniformly, the reaction was stirred uniformly with a magnetic rotor, and with stirring, the reactive hydrophilic copolymer obtained in Example 1 was added slowly (at a weight ratio of 6.5% of the total weight of the monomers) so that it was dissolved completely and dispersed uniformly in the solution. Next, the solution was heated to 60° C. for 2-4 hr while being stirred. After the formulation solution was cooled completely, the photoinitiator D1173 (0.2-1%) was added. The solution was poured into clamping plates made of PP with a known thickness, and photoinitiation was performed for 30 min to 2 hr under irradiation conditions of 2-5 mw/cm². After the reaction was completed, the gel sheet was removed from the clamping plates and immersed in 70/30 (ethanol/water) for swelling and extraction for about 1-2 hr, and then restored in saline for 1-2 hr, to get a flat film.

### Example 8

The ratios of the formulation main body were the same as those in Example 7, but the reactive hydrophilic copolymer prepared in Example 2 was added instead (at a weight ratio of 6.5% of the total weight of the monomers), and similarly, after it was completely dissolved in the whole formulation, the solution was heated to 60° C. for 2-4 hr while being stirred. A flat film was obtained by the same film-forming and releasing process.

### Example 9

The ratios of the formulation main body were the same as those in Example 7, but the reactive hydrophilic copolymer prepared in Example 3 was added instead (at a weight ratio of 6.5% of the total weight of the monomers), and similarly, after it was completely dissolved in the whole formulation, the solution was heated to 60° C. for 2-4 hr while being stirred. A flat film was obtained by the same film-forming and releasing process.

### Example 10

The ratios of the formulation main body were the same as those in Example 7, but the reactive hydrophilic copolymer prepared in Example 4 was added instead (at a weight ratio of 6.5% of the total weight of the monomers), and similarly, after it was completely dissolved in the whole formulation, the solution was heated to 60° C. for 2-4 hr while being stirred. A flat film was obtained by the same film-forming and releasing process.

### Example 11

The ratios of the formulation main body were the same as those in Example 7, but the reactive hydrophilic copolymer prepared in Example 5 was added instead (at a weight ratio of 6.5% of the total weight of the monomers), and similarly, after it was completely dissolved in the whole formulation, the solution was heated to 60° C. for 2-4 hr while being stirred. A flat film was obtained by the same film-forming and releasing process.

### Example 12

The ratios of the formulation main body were the same as those in Example 7, but the reactive hydrophilic copolymer prepared in Example 6 was added instead (at a weight ratio of 6.5% of the total weight of the monomers), and similarly, after it was completely dissolved in the whole formulation, the solution was heated to 60° C. for 2-4 hr while being stirred. A flat film was obtained by the same film-forming and releasing process.

### Example 13

The reactive hydrophilic copolymer prepared in Example 1 was uniformly mixed with TPM, HEMA, EGDMA, and hexanol into a homogeneous solution (first solution), in which the weight ratio of TPM/HEMA/EGDMA/hexanol/reactive hydrophilic copolymer was 29.9/70/0.1/3/5. The first solution was further mixed at 60° C. for 1 hr, so that TPM and the reactive hydrophilic copolymer prepared in Example 1 could be hydrolyzed completely. Once the formulation solution was cooled to room temperature, the initiator D1173 was added at a weight ratio of 0.5-1% of the total weight of the monomers, to form a second solution. The second solution was poured into clamping plates made of PP with a known thickness, and photoinitiation was performed for 30 min to 2 hr under irradiation conditions of 2-5 mw/cm². After the reaction was completed, the gel sheet was removed from the clamping plates and immersed in 70/30 (ethanol/water) for swelling and extraction for about 1-2 hr, and then restored in saline for 1-2 hr, to get a flat film.

### Example 14

The ratios of the formulation main body were the same as those in Example 7. After being mixed uniformly, the solution was stirred with a magnetic rotor uniformly, and with stirring, the reactive hydrophilic copolymer prepared in Example 4 was slowly added (at a weight ratio of 10% of the total weight of the silicone hydrogel monomer mixture), so that it was completely dissolved and dispersed uniformly. Then, the solution was heated to 60° C. for 2-4 hr while being stirred. After the formulation solution was completely cooled, the photoinitiator D1173 (0.7 wt %) was added. A flat film was then obtained with the same photo curing and mold releasing post-treatment as that in the previous examples.

### Comparative Example 1

The ratios of the formulation main body were the same as those in Example 7. After being mixed uniformly, the solution was stirred with a magnetic rotor uniformly, and without adding the reactive hydrophilic copolymer of the present invention, 0.7 wt % of the photoinitiator D1173 was directly added. The formulation solution was poured into clamping plates made of PP with a known thickness, and photoinitiation was performed for 30 min to 2 hr under irradiation conditions of 2-5 mw/cm². After the reaction was completed, the gel sheet was removed from the clamping plates and immersed in 70/30 (ethanol/water) for swelling and extraction for about 1-2 hr, and then restored in saline for 1-2 hr, to get a flat film.

### Comparative Example 2

The ratios of the formulation main body were the same as those in Example 7. After being mixed uniformly, the solution was stirred with a magnetic rotor uniformly, and with stirring, PVP-K90 (with a molecular weight of about 1,300,000) was slowly added (at a weight ratio of 10% of the total weight of the silicone hydrogel monomer mixture). After PVP was completely dissolved and dispersed uniformly, 0.7 wt % of the photoinitiator D1173 was added. A flat film was then obtained with the same photo curing and mold releasing post-treatment as those in the previous examples.

EDX Test of Wetting Agents Obtained at Different Feed Ratios

The reactive hydrophilic copolymers synthesized in Example 1, Example 5, and Example 6 were subjected to X-ray fluorescence analysis (EDX) test, to evaluate the variation of the element ratio Si/0 contained therein at different feed ratios.

TABLE 1

| | Example 1 | Example 5 | Example 6 |
|---|---|---|---|
| g of NVP feed | 30 g | 30 g | 30 g |
| g of VTMOS feed | 0.4 g | 4 g | 2 g |
| NVP/VTMOS equivalent ratio | 100/1 | 10/1 | 20/1 |
| (m/n) | | | |
| Theoretical value of element O/Si | 103/1 | 13/1 | 23/1 |
| in product | | | |
| Si content by EDX (Atomic %) | 0.45 | 1.7 | 0.7 |
| O content by EDX (Atomic %) | 13.91 | 17.24 | 16.72 |

Take Example 6 as example, the reaction formula is as shown in Scheme 1 below. The feed ratio of NVP and VTMOS is 20:1, and theoretically m:n should be 20:1 in the resulting product wetting agent (the structure on the right of Scheme 1), so the theoretical value of element 0/Si in the product should be 23:1. Therefore, on the basis of different feed ratios of NVP and VTMOS, wetting agents of different m/n could be obtained.

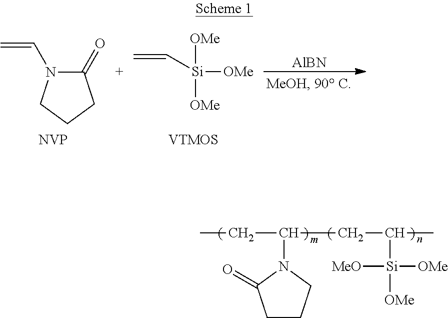

Chemical Bonding Test of Reactive Hydrophilic Copolymer

4 g TPM and 1 g the reactive hydrophilic copolymer powder prepared in Example 1 were placed in a reaction bottle, 20 mL ethanol was added, the reaction was performed for 6 hr at 60° C., and then ethanol was removed with a rotary evaporator. The residue was extracted with n-hexane and water three times, and the aqueous layer was collected and dried with a freeze dryer, to get a white flake, which was dissolved in D₂O for NMR identification.

As TPM is not soluble in water, but soluble in n-hexane, after extraction, unreacted TPM monomers can be removed into the organic layer, while two compounds will be obtained in the aqueous layer, that is, unreacted reactive hydrophilic copolymer, and the reaction product of the reactive hydrophilic copolymer and TPM. Therefore, if the signal of double bond appears in the NMR spectrum of the aqueous layer, it is verified that the reactive hydrophilic copolymer and TPM actually form a chemical bond therebetween.

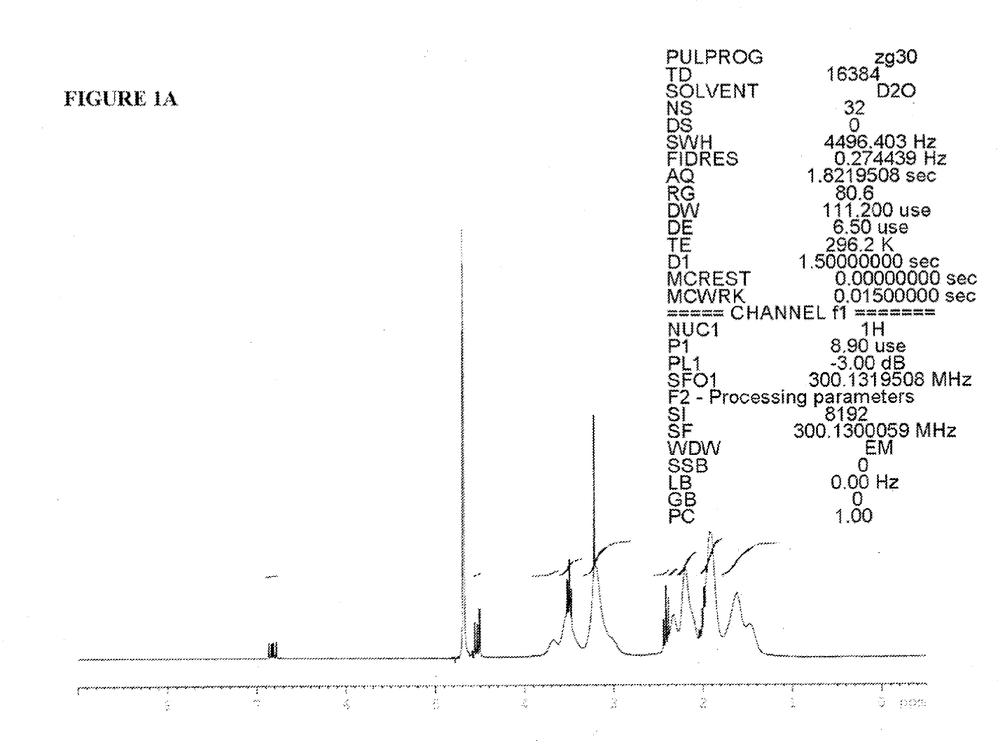

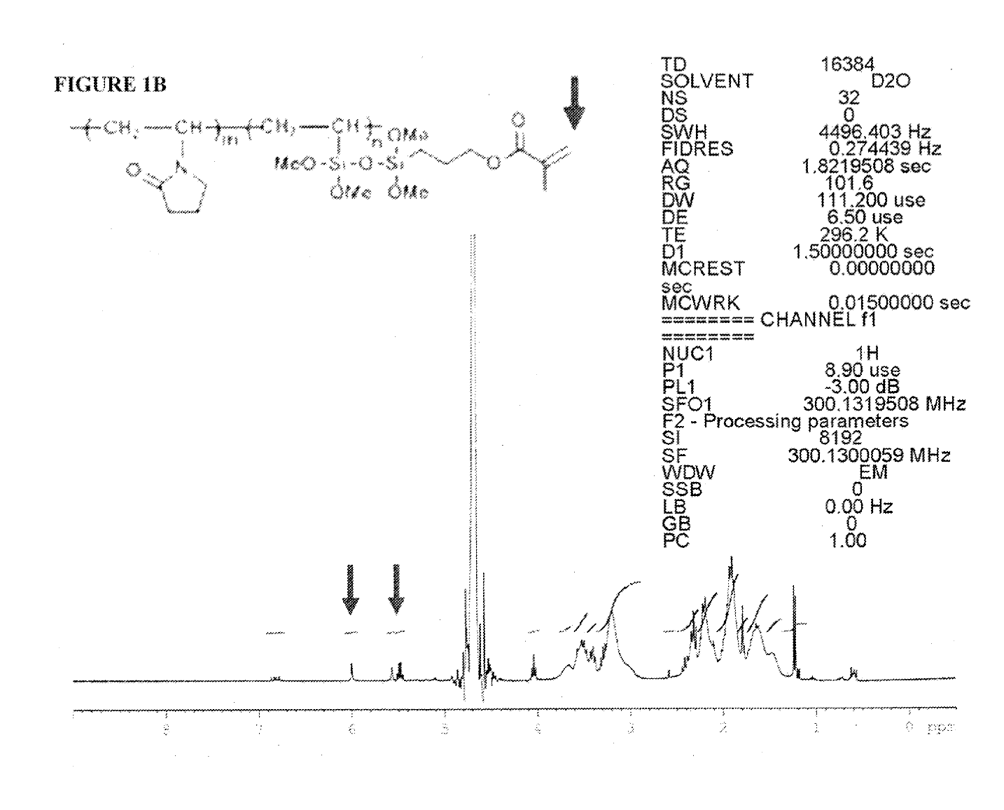

It can be known from the NMR result of FIG. 1 that no signal of double bond exists between 5 and 6 ppm in the spectrum of the reactive hydrophilic copolymer alone, while the signal of double bond (as indicated by the arrow) can be observed between 5 and 6 ppm in the spectrum of the aqueous layer after the product is extracted, so it is verified that the reactive hydrophilic copolymer and the silicone monomer having alkoxy silane functional groups (TPM) actually form a chemical bond.

Transmittance Test

1. DU 800 UV/Visible Spectrophotometer was used for detection of transmittance. The “full wavelength scan” mode was set, and the wavelength range was set between 400 and 700 nm.

2. Before detection of the transmittance of the sample, deionized water was poured into a quartz tank, which was then placed in a sample detection cell. “BLANK” was pressed for background subtraction.

3. The sample was cut to fit the size of the transparent face of a quartz tank, and applied onto the tank wall as smoothly as possible, and then deionized water was poured in, during which the generation and remaining of bubbles should be avoided. The tank was placed in a sample detection cell. “SCAN” was pressed to initiate detection of transmittance in the visible wavelength range.

4. Data processing: In order to compare the transmittance of films in different groups, 600 nm was initially set as the indicator for comparison of samples.

Contact Angle Test

1. The surface wetting property of the material was detected with DSA10. It should be first ensured that the image focal length has reached the optimal value before the detection.

2. The material was cut into films of suitable size, placed on the platform for contact angle measurement and spread out smoothly, and the water on the surface was wiped away. Droplets were dropped onto the surface of the sample with a needle tip.

3. After the image was acquired, the contact angle value of the liquid/solid interface was analyzed with software.

Table 2 shows the measurement data of the surface contact angle and transmittance of the silicone hydrogel films prepared in Examples 7 to 14 and Comparative Examples 1 and 2.

TABLE 2

| | | | | | | Example | Example |
|---|---|---|---|---|---|---|---|
| | | | Example 7 | Example 8 | Example 9 | 10 | 11 |
| Silicone | silicone | TMP (wt %) | 7.3 | 7.3 | 7.3 | 7.3 | 7.3 |
| Hydrogel | monomer | TRIS (wt %) | 32.83 | 32.83 | 32.83 | 32.83 | 32.83 |
| Composition | | CoatOsil (wt %) | 14.62 | 14.62 | 14.62 | 14.62 | 14.62 |
| | hydrophilic | NVP (wt %) | 31.66 | 31.66 | 31.66 | 31.66 | 31.66 |
| | monomer | HEMA (wt %) | 12.25 | 12.25 | 12.25 | 12.25 | 12.25 |
| | | MA (wt %) | 1.34 | 1.34 | 1.34 | 1.34 | 1.34 |
| | | EGDMA (wt %) | 1.34 | 1.34 | 1.34 | 1.34 | 1.34 |
| Reactive Hydrophilic | | Example 1 | 6.5 | — | — | — | — |
| Copolymer | | Example 2 | — | 6.5 | — | — | — |
| (wt %; based on the | | Example 3 | — | — | 6.5 | — | — |
| total weight of the | | Example 4 | — | — | — | 6.5 | — |
| monomers) | | Example 5 | — | — | — | — | 6.5 |
| | | Example 6 | — | — | — | — | — |
| | | PVP (1300K) | — | — | — | — | — |
| Contact Angle | | | 62.79° ± 3.11° | 59.41° ± 1.92° | 53.63° ± 2.15° | 49.33° ± 2.97° | 66.13° ± 3.26° |
| Transmittance | | | 98.80% | 97.50% | 97.10% | 96.90% | 97.90% |
| | | | Example | Example | Example | Comparative | Comparative |
| | | | 12 | 13 | 14 | Example 1 | Example 2 |
| Silicone | silicone | TMP (wt %) | 7.3 | 29.9 | 7.3 | 7.3 | 7.3 |
| Hydrogel | monomer | TRIS (wt %) | 32.83 | — | 32.83 | 32.83 | 32.83 |
| Composition | | CoatOsil (wt %) | 14.62 | — | 14.62 | 14.62 | 14.62 |
| | hydrophilic | NVP (wt %) | 31.66 | — | 31.66 | 31.66 | 31.66 |
| | monomer | HEMA (wt %) | 12.25 | 70 | 12.25 | 12.25 | 12.25 |
| | | MA (wt %) | 1.34 | — | 1.34 | 1.34 | 1.34 |
| | | EGDMA (wt %) | 1.34 | 0.1 | 1.34 | 1.34 | 1.34 |

| | | | | | | |
|---|---|---|---|---|---|---|
| Reactive Hydrophilic | Example 1 | — | 5 | — | — | — |
| Copolymer | Example 2 | — | — | — | — | — |
| (wt %; based on the | Example 3 | — | — | — | — | — |
| total weight of the | Example 4 | — | — | 10 | — | — |
| monomers) | Example 5 | — | — | — | — | — |
| | Example 6 | 6.5 | — | — | — | — |
| | PVP (1300K) | — | — | — | — | 10 |

| | | | | | |
|---|---|---|---|---|---|
| Contact Angle | 64.47° ± 1.88° | 35.86° ± 4.27° | 46.36° ± 3.91° | 93.71° ± 3.18° | 64.73° ± 2.94° |
| Transmittance | 97.80% | 98.20% | 94.30% | 98.70% | 62.20% |

The formulation main body of Comparative Example 1 was the same as those of Examples 7 to 12 and Example 14, except that in Examples 7 to 12 and Example 14, the reactive hydrophilic copolymer synthesized in Examples 1 to 6 was added. It can be seen from Table 2 that the wettability of the surface of the silicone hydrogel material containing the reactive hydrophilic copolymer of the present invention is significantly improved, and the addition of the reactive hydrophilic copolymer almost has no impact on the transmittance of the silicone hydrogel material, which indicates that the reactive hydrophilic copolymer has excellent compatibility with the silicone hydrogel material.

The formulation main body of Comparative Example 2 was the same as that of Example 14. The difference between them was in that the wetting agent added in Comparative Example 2 was the PVP molecule having a molecular weight up to 1,300,000 g/mol, with no alkoxyl silane reactive functional groups capable of reacting with the formulation main body, and the wetting agent added in Example 14 was the reactive hydrophilic copolymer synthesized in Example 4 having an average molecular weight of 1244112 g/mol. It can be seen from the transmittance data in Table 2 that the reactive hydrophilic copolymer of the present invention has excellent compatibility with the formulation main body. Furthermore, it can also be seen from the contact angle data that, with similar molecular weight ranges, the reactive hydrophilic copolymer of the present invention is superior to PVP in wetting effect. It can thus be concluded that the reactive hydrophilic copolymer of the present invention and the formulation main body form a chemical bond.

It should be understood that various modifications of the present invention are feasible and can be easily appreciated and expected by those skilled in the art.

1. A reactive hydrophilic copolymer, consisting essentially of units formed by ethylenically unsaturated hydrophilic monomers and units of formula (I) or (II) formed by ethylenically unsaturated monomers having alkoxy silane functional groups in a random order: 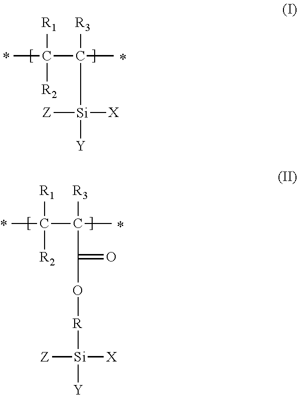
wherein the copolymer has a molecular weight of at least 50,000, and wherein R₁, R₂ and R₃ are the same or different and are independently H or C₁₋₃ alkyl; R is C₁₋₃ alkyl; X, Y and Z are the same or different and are independently selected from R′ or OR′, provided that at least one of X, Y and Z is OR′; R′ is H or C₁₋₃ alkyl; and the equivalent ratio of the units formed by ethylenically unsaturated hydrophilic monomers to the units of formula (I) or (II) is within the range of 5/1 to 200/1.

2. The reactive hydrophilic copolymer according to claim 1, wherein the reactive hydrophilic copolymer is obtained by copolymerizing one or more hydrophilic monomers having ethylenically unsaturated functional groups and one or more ethylenically unsaturated monomers having alkoxy silane functional groups in the presence of an initiator, wherein the initiator is selected from the group consisting of 2,2′-azobis(isobutyronitrile) (AIBN), 2,2′-azobis(2,4-dimethylpentanenitrile) 2,2′-azobis(2-methylpropanenitrile), 2,2′-azobis(2-methylbutanenitrile), benzyl peroxide, acetyl peroxide, lauroyl peroxide, decanoyl peroxide, stearoyl peroxide, benzoyl peroxide, tert-butyl peroxypivalate, peroxydicarbonate, and the like, and mixtures thereof.

3. The reactive hydrophilic copolymer according to claim 1, wherein the ethylenically unsaturated hydrophilic monomers are selected from the group consisting of ethylenically unsaturated carboxylic acid, hydrophilic vinyl carbonate, acrylate, vinyl amide, vinyl lactam, acrylamide, and mixtures thereof.

4. The reactive hydrophilic copolymer according to claim 3, wherein the ethylenically unsaturated hydrophilic monomers are selected from the group consisting of methacrylic acid (MA), acrylic acid, vinyl acetate, ethylene glycol dimethacrylate (EGDMA), 2-hydroxyethyl methacrylate (HEMA), 2-hydroxyethyl acrylate, glycerol methacrylate, 2-dimethylaminoethyl acrylate, N-vinyl-N-methyl acetamide, N-vinyl-formamide, N-vinyl pyrrolidone (NVP), acryloylmorpholine, methacrylamide, N,N-dimethylacrylamide (DMA), N,N-diethylacrylamide, 2-hydroxyethyl methacrylamide, N-isopropylacrylamide, and mixture thereof.

5. The reactive hydrophilic copolymer according to claim 1, wherein the ethylenically unsaturated monomers having alkoxy silane functional groups are selected from the group consisting of vinyltrimethoxysilane, vinyltriethoxysilane, diethoxy(methyl)vinylsilane, 3-methacryloxypropyl-methyldimethoxysilane, 3-methacryloxypropyl-methyldiethoxysilane, 3-methacryloxypropyl-trimethoxysilane, 3-methacryloxypropyl-triethoxysilane, vinyltri(isopropoxy)silane, vinyltripropoxysilane, and mixtures thereof.

6. The reactive hydrophilic copolymer according to claim 1, wherein the equivalent ratio of the units formed by ethylenically unsaturated hydrophilic monomers to the units of formula (I) or (II) is within the range of 10/1 to 150/1.

7. The reactive hydrophilic copolymer according to claim 6, wherein the equivalent ratio of the units formed by ethylenically unsaturated hydrophilic monomers to units for formula (I) or (II) is within the range of 20/1 to 100/1.

8. The reactive hydrophilic copolymer according to claim 1, wherein the reactive hydrophilic copolymer has a molecular weight of 80,000 to 1,300,000.

9. A silicone hydrogel composition, comprising:
(a) a monomer mixture for forming a silicone hydrogel, wherein the monomer mixture comprises at least one silicone monomer having alkoxy silane functional groups; and
(b) the reactive hydrophilic copolymer according to claim 1.

10. The silicone hydrogel composition according to claim 9, wherein the reactive hydrophilic copolymer is used in an amount of 1 to 20 parts by weight, based on 100 parts by weight of the total weight of the monomer mixture for forming a silicone hydrogel.

11. The silicone hydrogel composition according to claim 10, wherein the reactive hydrophilic copolymer is used in an amount of 3 to 15 parts by weight, based on 100 parts by weight of the total weight of the monomer mixture for forming a silicone hydrogel.

12. The silicone hydrogel composition according to claim 9, wherein the monomer mixture for forming a silicone hydrogel comprises 10 to 70 parts by weight of the silicone monomers, based on 100 parts by weight of the total weight of the monomer mixture, wherein at least 5 parts by weight of the silicone monomers has alkoxy silane functional groups.

13. The silicone hydrogel composition according to claim 12, wherein the monomer mixture for forming a silicone hydrogel comprises 20 to 60 parts by weight of the silicone monomers, based on 100 parts by weight of the total weight of the monomer mixture, wherein at least 10 parts by weight of the silicone monomers has alkoxy silane functional groups.

14. The silicone hydrogel composition according to claim 13, wherein the silicone monomers in the monomer mixture are all silicone monomers having alkoxy silane functional groups.

15. The silicone hydrogel composition according to claim 9, wherein the silicone monomers having alkoxy silane functional groups are selected from the group consisting of 3-(trimethoxysilyl)propyl methacrylate (TPM), 3-(triethoxysilyl)propyl methacrylate, 3-(diethoxymethylsilyl)-propyl methacrylate, vinyltrimethoxysilane, vinyltriethoxysilane, diethoxy(methyl)vinylsilane, 3-methacryloxypropyl-methyldimethoxysilane, 3-methacryloxypropyl-methyldiethoxysilane, 3-methacryloxypropyl-trimethoxysilane, 3-methacryloxypropyl-triethoxysilane, vinyltri(isopropoxy)silane, vinyltripropoxysilane, and mixtures thereof.

16. The silicone hydrogel composition according to claim 9, wherein the monomer mixture for forming the silicone hydrogel comprises silicone monomers free of alkoxy silane functional groups selected from the group consisting of tris(trimethylsiloxy)silylpropyl methacrylate, bis(trimethylsiloxy)methylsilylpropyl methacrylate, pentamethyldisiloxanepropyl methacrylate, tris(trimethylsiloxy)silyl propyloxyethyl methacrylate, tris(polydimethylsiloxy)silylpropyl methacrylate, (trimethylsiloxy)3-methacryloxypropylsilane (TRIS), ethylenically unsaturated organic siloxane prepolymers, and mixtures thereof.

17. The silicone hydrogel composition according to claim 9, wherein the monomer mixture for forming the silicone hydrogel comprises ethylenically unsaturated hydrophilic monomers selected from the group consisting of methacrylic acid (MA), acrylic acid, vinyl acetate, ethylene glycol dimethacrylate (EGDMA), 2-hydroxyethyl methacrylate (HEMA), 2-hydroxyethyl acrylate, glycerol methacrylate, 2-dimethylaminoethyl acrylate, N-vinyl-N-methyl acetamide, N-vinyl-formamide, N-vinyl pyrrolidone (NVP), acryloylmorpholine, methacrylamide, N,N-dimethylacrylamide (DMA), N,N-diethylacrylamide, 2-hydroxyethyl methacrylamide, N-isopropylacrylamide, and mixtures thereof.

18. The silicone hydrogel composition according to claim 17, wherein the ethylenically unsaturated hydrophilic monomers are used in an amount of 30 to 90 parts by weight, based on 100 parts by weight of the total weight of the monomer mixture for forming a silicone hydrogel.

19. The silicone hydrogel composition according to claim 18, wherein the ethylenically unsaturated hydrophilic monomers are used in an amount of 40 to 80 parts by weight, based on 100 parts by weight of the total weight of the monomer mixture for forming a silicone hydrogel.

20. An ocular article made from the silicone hydrogel composition according to claim 9, being contact lenses or intraocular lens.
